(19) United States
(12) Patent Application Publication
(10) Pub. No.: US 2026/0285283 A1
(43) Pub. Date: Sep. 24, 2026

(54) APPARATUS AND METHOD FOR DETECTING FAILURE OF DRIVING MOTOR OF ELECTRONIC PARKING BRAKE

(71) Applicant: HYUNDAI MOBIS CO., LTD., Seoul (KR)

(72) Inventor: Jin Hyo PARK, Yongin-si (KR)

(73) Assignee: HYUNDAI MOBIS CO., LTD., Seoul (KR)

(21) Appl. No.: 19/563,523

(22) Filed: Mar. 11, 2026

(30) Foreign Application Priority Data
Mar. 21, 2025 (KR) 10-2025-0036771

(51) Int. Cl. B60T 17/22; B60T 13/74

(52) U.S. Cl. CPC B60T 17/221; B60T 13/741; B60T 2270/406; B60T 2270/415

(57) ABSTRACT

An apparatus for detecting a failure of a driving motor of an electronic parking brake includes a power terminal current detection module detecting a current flowing through a power terminal of an H-bridge module; a ground terminal current detection module detecting a current flowing through a ground terminal of the H-bridge module; a voltage detection module detecting a motor voltage across both ends of the driving motor; a driving module switching the H-bridge module according to a brake operation signal to drive the driving motor, and applying a set voltage to both ends of the driving motor; and a processor determining a failure detection condition, and detecting a failure of the driving motor by repeating, a set number of times, a process of comparing the motor voltage and set voltage, measuring each of a power terminal current and a ground terminal current and comparing it with a reference current.

### CROSS-REFERENCE TO RELATED APPLICATION

This application claims priority from and the benefit of Korean Patent Application No. 10-2025-0036771, filed on Mar. 21, 2025, which is hereby incorporated by reference for all purposes as if set forth herein.

### BACKGROUND

### Field

The present disclosure relates to an apparatus and method for detecting a failure of a driving motor of an electronic parking brake, and more particularly, to an apparatus and method for detecting a failure of a driving motor of an electronic parking brake that detects a power short failure and a ground short failure of a driving motor that drives an electronic parking brake.

### Discussion of the Background

In general, a parking brake system is mounted in a vehicle in order to safely maintain the vehicle in a stopped state during parking.

Such a parking brake system has generally employed a method of controlling brake pads by using a mechanical cable. However, recently, with the development of electronic control technology, an electronic parking brake (EPB) has been gradually becoming widespread.

The electronic parking brake (EPB) uses a driving motor of a brake system of a vehicle to operate brake pads, and allows a driver to operate a parking brake through a button without a separate physical manipulation. An EPB system has advantages of increasing driving convenience, being able to be linked with an automatic parking function, and improving the safety of the vehicle.

One of core components of such an electronic parking brake system is the driving motor that serves to open and close brake pads. The driving motor operates according to a command from an electronic control unit (ECU) to engage or release a brake.

However, when the driving motor fails or does not normally operate, the parking brake may not normally operate, which may seriously affect the safety of the vehicle. For example, when the motor does not operate due to an abnormality of an internal circuit of the motor, mechanical sticking of a driving shaft or a problem in power supply, a driver may face a situation in which the driver is unable to engage or release the parking brake. Such a problem may lead to a serious accident particularly in a situation requiring parking on a slope or emergency braking during movement of the vehicle.

Therefore, in order to improve the reliability of the EPB system, a technology capable of promptly and accurately detecting a failure of the driving motor is required.

The above-described information disclosed in the Background of the present disclosure is intended only to provide a better understanding of the Background of the present disclosure and may therefore include information that does not constitute the related art.

### SUMMARY

Such an electronic parking brake detects a failure by monitoring voltages at both ends of the driving motor and comparing the voltages with a set reference voltage.

However, since a short failure is detected by relying only on voltages at both ends of the driving motor, a case of false detection occurs due to instability of a battery voltage or external electromagnetic noise.

That is to say, when a battery voltage becomes unstable during starting of the vehicle, power supplied to a control device is also unstable, and thus, when voltages at both ends of the driving motor are not constantly maintained and become unstable, a problem occurs in that a short failure of the driving motor is falsely detected.

In addition, even when voltages at both ends of the driving motor fluctuate unstably due to external electromagnetic noise, there is a problem in that a failure is detected.

The present disclosure has been made to solve the above-described problems, and an object of the present disclosure according to one aspect is to provide an apparatus and method for detecting a failure of a driving motor of an electronic parking brake, which repeatedly measures voltages and currents at both ends of the driving motor in a standby state of the electronic parking brake to detect a power short failure and a ground short failure of the driving motor.

The problem to be solved by the present disclosure is not limited to the problem mentioned above, and other problems not mentioned will be clearly understood by those skilled in the art from the following description.

An apparatus for detecting a failure of a driving motor of an electronic parking brake according to one aspect of the present disclosure includes: a power terminal current detection module configured to detect a current flowing through a power terminal of an H-bridge module that supplies power to a driving motor; a ground terminal current detection module configured to detect a current flowing through a ground terminal of the H-bridge module; a voltage detection module configured to detect a motor voltage across both ends of the driving motor; a driving module configured to switch the H-bridge module according to a brake operation signal to drive the driving motor, and apply a set voltage to both ends of the driving motor; and a processor operatively coupled to the power terminal current detection module, the ground terminal current detection module, the voltage detection module and the driving module, wherein the processor determines a failure detection condition based on an operation state of a parking brake and a state of a battery inputted from a data input module, and detects a failure of the driving motor by repeating, a set number of times, a process of comparing the motor voltage and the set voltage, measuring each of a power terminal current and a ground terminal current and comparing each of the power terminal current and the ground terminal current with a reference current.

In the present disclosure, the failure detection condition is that the parking brake is in a standby state in which the parking brake is not operated and a voltage of the battery is in a stable state.

In the present disclosure, when the motor voltage is equal to or less than a voltage obtained by subtracting a reference voltage from the set voltage, the processor turns on upper switches of the H-bridge module through the driving module, measures the ground terminal current, repeats the process the set number of times when the ground terminal current exceeds the reference current, and outputs a ground short failure of the driving motor.

In the present disclosure, when repeating the process the set number of times, the processor resets the driving module, applies the set voltage to both ends of the driving motor, turns off the upper switches of the H-bridge module, and then repeats the process.

In the present disclosure, when the motor voltage is equal to or greater than a voltage obtained by adding a reference voltage to the set voltage, the processor turns on lower switches of the H-bridge module through the driving module, measures the power terminal current, repeats the process the set number of times when the power terminal current exceeds the reference current, and outputs a power short failure of the driving motor.

In the present disclosure, when repeating the process the set number of times, the processor resets the driving module, applies the set voltage to both ends of the driving motor, turns off the lower switches of the H-bridge module, and then repeats the process.

A method for detecting a failure of a driving motor of an electronic parking brake according to another aspect of the present disclosure includes: determining, by a processor, a failure detection condition based on an operation state of a parking brake and a state of a battery inputted from a data input module; comparing, by the processor, a motor voltage of a driving motor and a set voltage when the failure detection condition is satisfied; measuring, by the processor, a ground terminal current after turning on upper switches of an H-bridge module through a driving module when, by comparing the motor voltage and the set voltage, the motor voltage is equal to or less than a voltage obtained by subtracting a reference voltage from the set voltage; repeating, a set number of times by the processor, a process of measuring and comparing the motor voltage and the ground terminal current when, by comparing the ground terminal current and a reference current, the ground terminal current exceeds the reference current; and determining a ground short failure of the driving motor after the processor repeats the process the set number of times, and outputting a result.

In the present disclosure, in the repeating, a set number of times, a process of measuring and comparing the motor voltage and the ground terminal current, the processor resets the driving module, applies the set voltage to both ends of the driving motor, turns off the upper switches of the H-bridge module, and then repeats the process.

A method for detecting a failure of a driving motor of an electronic parking brake according to still another aspect of the present disclosure includes: determining, by a processor, a failure detection condition based on an operation state of a parking brake and a state of a battery inputted from a data input module; comparing, by the processor, a motor voltage of a driving motor and a set voltage when the failure detection condition is satisfied; measuring, by the processor, a power terminal current after turning on lower switches of an H-bridge module through a driving module when, by comparing the motor voltage and the set voltage, the motor voltage is equal to or greater than a voltage obtained by adding a reference voltage to the set voltage; repeating, a set number of times by the processor, a process of measuring and comparing the motor voltage and the power terminal current when, by comparing the power terminal current and a reference current, the power terminal current exceeds the reference current; and determining a power short failure of the driving motor after the processor repeats the process the set number of times, and outputting a result.

In the present disclosure, in the repeating, a set number of times, a process of measuring and comparing the motor voltage and the power terminal current, the processor resets the driving module, applies the set voltage to both ends of the driving motor, turns off the lower switches of the H-bridge module, and then repeats the process.

An apparatus and method for detecting a failure of a driving motor of an electronic parking brake according to one aspect of the present disclosure repeatedly measures voltages and currents at both ends of the driving motor in a standby state of the electronic parking brake to detect a power short failure and a ground short failure of the driving motor, whereby it is possible to accurately detect a short failure of the driving motor even in a situation of voltage instability and electromagnetic noise.

However, the effects that may be obtained by the present disclosure are not limited to the effects described above, and other technical effects not mentioned will be clearly understood by those skilled in the art from the following description of the present disclosure.

### BRIEF DESCRIPTION OF THE DRAWINGS

FIG. 1 is a block diagram illustrating an apparatus for detecting a failure of a driving motor of an electronic parking brake according to an embodiment of the present disclosure.

FIG. 2 is a circuit configuration diagram for detecting a ground short failure in the apparatus for detecting a failure of a driving motor of an electronic parking brake according to the embodiment of the present disclosure.

FIG. 3 is a circuit configuration diagram for detecting a power short failure in the apparatus for detecting a failure of a driving motor of an electronic parking brake according to the embodiment of the present disclosure.

FIG. 4 is a flowchart for explaining a method for detecting a ground short failure in a method for detecting a failure of a driving motor of an electronic parking brake according to an embodiment of the present disclosure.

FIG. 5 is a flowchart for explaining a method for detecting a power short failure in the method for detecting a failure of a driving motor of an electronic parking brake according to the embodiment of the present disclosure.

### DETAILED DESCRIPTION OF THE ILLUSTRATED EMBODIMENTS

Hereinafter, embodiments of an apparatus and method for detecting a failure of a driving motor of an electronic parking brake according to embodiments of the present disclosure will be described.

In this process, the thicknesses of lines and the sizes of components depicted in the drawings may be exaggerated for clarity and convenience of explanation. Furthermore, the terms to be described below are terms defined in consideration of the functions in the present disclosure, and may be changed depending on the intention or custom of users or operators. Therefore, definitions of these terms should be made according to the overall disclosures set forth herein.

Hereinafter, embodiments of the present disclosure will be described in detail with reference to the accompanying drawings so that those skilled in the art can easily carry out the present disclosure. The present disclosure may, however, be embodied in many different forms and should not be construed as being limited to the embodiments set forth herein. In order to clearly explain the present disclosure, in the drawings, parts irrelevant to the explanation are omitted, and similar parts are given similar reference numerals throughout the specification.

Throughout the specification, when an element “includes” a component, it may indicate that the element does not exclude another component unless referred to the contrary, but can further include another component.

Furthermore, an implementation described in this specification may be realized as a method or a process, an apparatus, a software program, a data stream or a signal, for example. Although the disclosure is discussed only in the context of a single form of an implementation (e.g., discussed as only a method), an implementation having a discussed characteristic may also be realized in another form (e.g., an apparatus or a program). The apparatus may be implemented as proper hardware, software or firmware. The method may be implemented in an apparatus, such as a processor commonly referring to a processing device, including a computer, a microprocessor, an integrated circuit or a programmable logic device, for example.

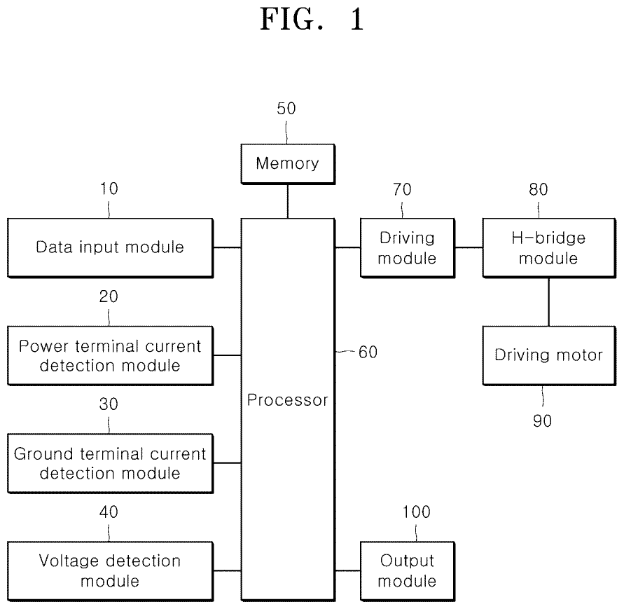

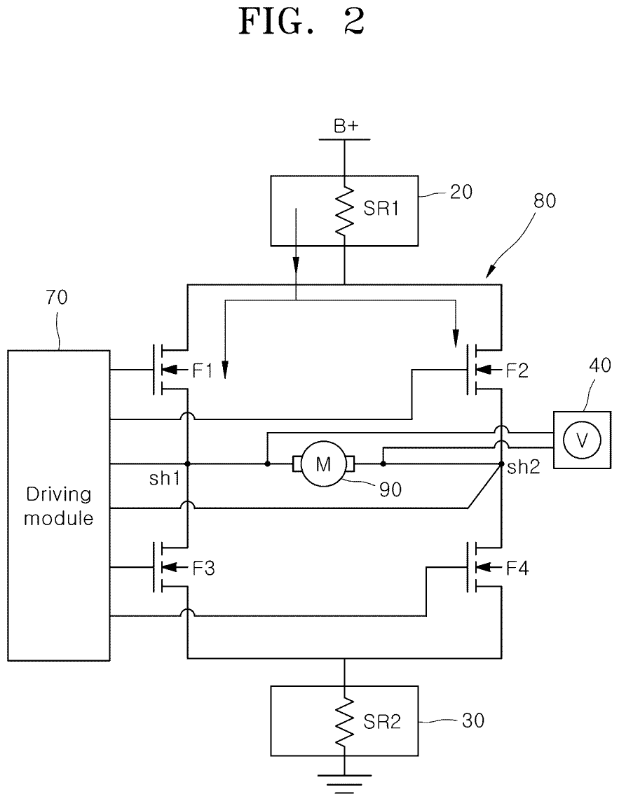

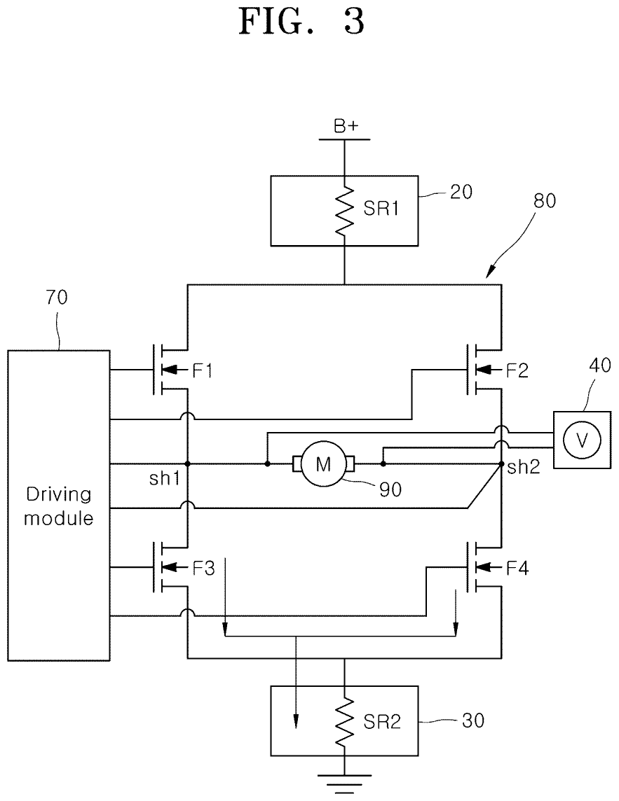

FIG. 1 is a block diagram illustrating an apparatus for detecting a failure of a driving motor of an electronic parking brake according to an embodiment of the present disclosure, FIG. 2 is a circuit configuration diagram for detecting a ground short failure in the apparatus for detecting a failure of a driving motor of an electronic parking brake according to the embodiment of the present disclosure, and FIG. 3 is a circuit configuration diagram for detecting a power short failure in the apparatus for detecting a failure of a driving motor of an electronic parking brake according to the embodiment of the present disclosure.

As illustrated in FIG. 1 to FIG. 3, the apparatus for detecting a failure of a driving motor of an electronic parking brake according to the embodiment of the present disclosure may include an H-bridge module 80, a data input module 10, a power terminal current detection module 20, a ground terminal current detection module 30, a voltage detection module 40, a driving module 70, an output module 100, a memory 50, and a processor 60. In some embodiments, the power terminal current detection module 20, the ground terminal current detection module 30, and the voltage detection module 40 may be referred to as a power terminal current detector, a ground terminal current detector, and a voltage detector. In some embodiments, the driving module 70 may be referred to as a motor controller. According to an exemplary embodiment of the present disclosure, the apparatus may include one or more processors (e.g., computer, microprocessor, CPU, ASIC, circuitry, logic circuits, etc.) and an associated non-transitory memory storing software instructions which, when executed by the processor, provides the functionalities of the data input module 10, the power terminal current detection module 20, the ground terminal current detection module 30, the voltage detection module 40, the driving module 70, the output module 100. Herein, the memory and the processor may be implemented as separate semiconductor circuits. Alternatively, the memory and the processor may be implemented as a single integrated semiconductor circuit. The processor may embody one or more processor(s).

The H-bridge module 80 may control the speed and direction of a driving motor 90 by switching four first to fourth MOSFETs F1 to F4 to adjust the direction and time of power supplied to the driving motor 90.

More specifically, the H-bridge module 80 is a circuit for driving the driving motor 90, and the two first and second MOSFETs F1 and F2 are connected to an upper terminal, which is a power terminal of the driving motor 90, and the two third and fourth MOSFETs F3 and F4 are connected to a lower terminal, which is a ground terminal of the driving motor 90. The first MOSFET F1 and the third MOSFET F3 are connected in series, and the second MOSFET F2 and the fourth MOSFET F4 are connected in series.

Accordingly, the speed of the driving motor 90 may be controlled by a duty control method of varying switching frequencies of the first to fourth MOSFETs F1 to F4 using PWM control, and the rotation direction of the driving motor 90 may be controlled by differently selecting MOSFETs to be turned on or off among the first to fourth MOSFETs F1 to F4.

The data input module 10 may receive an operation state of an electronic parking brake and a voltage state of a battery for determining a failure detection condition from peripheral devices of a vehicle. In some embodiments, the data input module 10 may include a processor (e.g., computer, microprocessor, CPU, ASIC, circuitry, logic circuits, etc.) and an associated non-transitory memory storing software instructions which, when executed by the processor, provides the functionalities of the data input module 10. Herein, the memory and the processor may be implemented as separate semiconductor circuits. Alternatively, the memory and the processor may be implemented as a single integrated semiconductor circuit. The processor may embody one or more processor(s). In some embodiments, the data input module 10 may include, but is not limited to, various hardware components, such as sensors, switches, wireless communication modules. In some embodiments, the data input module 10 may be referred to as, but is not limited to, a data input interface, an input port, a data input receiver, data acquisition interface, sensor input.

That is to say, operation states of the electronic parking brake may be classified into a standby state, an apply state, a release state and a stop state.

The power terminal current detection module 20 may measure a power terminal current through a voltage applied to a first shunt resistor SR1 connected to a power terminal B+ of the H-bridge module 80.

The ground terminal current detection module 30 may measure a ground terminal current through a voltage applied to a second shunt resistor SR2 connected to a ground terminal of the H-bridge module 80.

The voltage detection module 40 may detect motor voltages at both ends of the driving motor 90, respectively.

The driving module 70 may drive the driving motor 90 by switching the H-bridge module 80 according to a brake operation signal, and may apply a set voltage to both ends of the driving motor 90.

The driving module 70 may apply a set voltage of about 4V to both ends of the driving motor 90 to maintain a stable state in a standby state.

The output module 100 may output a failure detection result through a display or an indicator lamp, or may output a failure detection result to peripheral devices to allow a driver to prepare.

The memory 50 may store data related with an execution program for the operation of the apparatus for detecting a failure of a driving motor of an electronic parking brake, and information to be stored may be independently selected by the processor 60 as necessary.

In other words, various types of data generated in the execution process of an operating system or an application (program or applet) for driving of the apparatus for detecting a failure of a driving motor of an electronic parking brake are stored in the memory 50. The memory 50 collectively refers to a nonvolatile storage device that continuously maintains stored information even when power is not supplied and a volatile storage device that requires power to maintain stored information. The memory 50 may perform a function of temporarily or permanently storing data to be processed by the processor 60.

The memory 50 may include magnetic storage media or flash storage media in addition to a volatile storage device that requires power to maintain stored information, but the scope of the present disclosure is not limited thereto.

The processor 60 is operatively coupled to the data input module 10, the power terminal current detection module 20, the ground terminal current detection module 30, the voltage detection module 40, the memory 50, the driving module 70 and the output module 100, and may copy various programs stored in the memory 50 to a RAM and execute the programs to perform various operations in order to control overall operations of the apparatus for detecting a failure of a driving motor of an electronic parking brake.

As various embodiments, the processor 60 may be implemented with a digital signal processor (DSP), a microprocessor or a time controller (TCON) that processes digital signals. However, the present disclosure is not limited thereto, and the processor 60 may include one or more of a central processing unit (CPU), a micro controller unit (MCU), a micro processing unit (MPU), a controller, an application processor (AP), a communication processor (CP) and an ARM processor, or may be defined by corresponding terms. In addition, the processor 60 may be implemented with a system on chip (SoC) or a large scale integration (LSI) with a built-in processing algorithm, or may be implemented in the form of a field programmable gate array (FPGA).

Namely, the processor 60 drives an execution program for the apparatus for detecting a failure of a driving motor of an electronic parking brake stored in the memory 50, and then, determines a failure detection condition based on an operation state of the parking brake and a state of the battery inputted from the data input module 10.

The processor 60 determines, as the failure detection condition, whether the parking brake is in a standby state in which the parking brake is not operated and whether a voltage of the battery is in a stable state.

When the electronic parking brake is in the standby state, the driving module 70 applies a set voltage of about 4V to both ends of the driving motor 90 to maintain a stable state.

Accordingly, the processor 60 may measure a motor voltage through the voltage detection module 40 and determine whether a voltage of about 4V, which is the set voltage, is measured, thereby detecting a short failure of the driving motor 90.

That is to say, if a reference voltage is set to 1V, when the motor voltage is equal to or less than a voltage obtained by subtracting the reference voltage from the set voltage, the processor 60 may detects a ground short failure when the motor voltage is equal to or less than 3V, and when the motor voltage is equal to or greater than a voltage obtained by adding the reference voltage to the set voltage, the processor 60 may detect a power short failure when the motor voltage is equal to or greater than 5V.

To explain this in detail, when the motor voltage is equal to or less than the voltage obtained by subtracting the reference voltage from the set voltage, as illustrated in FIG. 2, the processor 60 may turn on the first and second MOSFETs F1 and F2, which are upper switches of the H-bridge module 80, through the driving module 70, and then, may measure a ground terminal current through the ground terminal current detection module 30.

In this way, in a state where the first and second MOSFETs F1 and F2, which are the upper switches, are turned on and the third and fourth MOSFETs F3 and F4, which are lower switches, are turned off, a ground short of the driving motor 90 may be detected by measuring a ground terminal current to see whether a current flows to the ground terminal.

Accordingly, when the processor 60 measures the ground terminal current and compares the ground terminal current with a reference current, which is 10 A in the present embodiment, and when the ground terminal current exceeds the reference current, the processor 60 increases a failure count and repeats the process a set number of times. Then, when the ground terminal current continuously exceeds the reference current, the processor 60 may determine a ground short failure of the driving motor 90 and may output a failure detection result through the output module 100.

When repeating the process the set number of times, the processor 60 may repeat the process by resetting the driving module 70, applying the set voltage to both ends of the driving motor 90, turning off the upper switches F1 and F2 of the H-bridge module 80 and then increasing the failure count.

If the motor voltage is equal to or less than the voltage obtained by subtracting the reference voltage from the set voltage but the ground terminal current does not exceed the reference current, the processor 60 may determine a temporary voltage drop, and may repeat the above process by resetting the driving module 70, applying the set voltage to both ends of the driving motor 90, turning off the upper switches F1 and F2 of the H-bridge module 80 and then not increasing the failure count. In the case of such a temporary voltage drop, the processor 60 may reset the failure count.

When the motor voltage is equal to or greater than the voltage obtained by adding the reference voltage to the set voltage, as illustrated in FIG. 3, the processor 60 may turn on the third and fourth MOSFETs F3 and F4, which are lower switches of the H-bridge module 80, through the driving module 70, and then, may measure a power terminal current through the power terminal current detection module 20.

In this way, in a state where the third and fourth MOSFETs F3 and F4, which are the lower switches, are turned on and the first and second MOSFETs F1 and F2, which are the upper switches, are turned off, a power short of the driving motor 90 may be detected by measuring a power terminal current to see whether a current flows to the power terminal.

Accordingly, the processor 60 measures the power terminal current and compares the power terminal current with the reference current, which is 10 A in the present embodiment, and when the power terminal current exceeds the reference current, the processor 60 increases a failure count and repeats the process a set number of times. Then, when the power terminal current continuously exceeds the reference current, the processor 60 may determine a power short failure of the driving motor 90 and may output a failure detection result through the output module 100.

When repeating the process the set number of times, the processor 60 may repeat the process by resetting the driving module 70, applying the set voltage to both ends of the driving motor 90, turning off the lower switches F3 and F4 of the H-bridge module 80 and then increasing the failure count.

If the motor voltage is equal to or greater than the voltage obtained by adding the reference voltage to the set voltage but the power terminal current does not exceed the reference current, the processor 60 may determine a temporary voltage rise, and may repeat the process by resetting the driving module 70, applying the set voltage to both ends of the driving motor 90, turning off the lower switches F3 and F4 of the H-bridge module 80 and then not increasing the failure count. In the case of such a temporary voltage rise, the processor 60 may reset the failure count.

As is apparent from the above description, according to the apparatus for detecting a failure of a driving motor of an electronic parking brake according to the embodiment of the present disclosure, voltages and currents at both ends of the driving motor are repeatedly measured in a standby state of the electronic parking brake to detect a power short failure and a ground short failure of the driving motor, whereby it is possible to accurately detect a short failure of the driving motor even in a situation of voltage instability and electromagnetic noise.

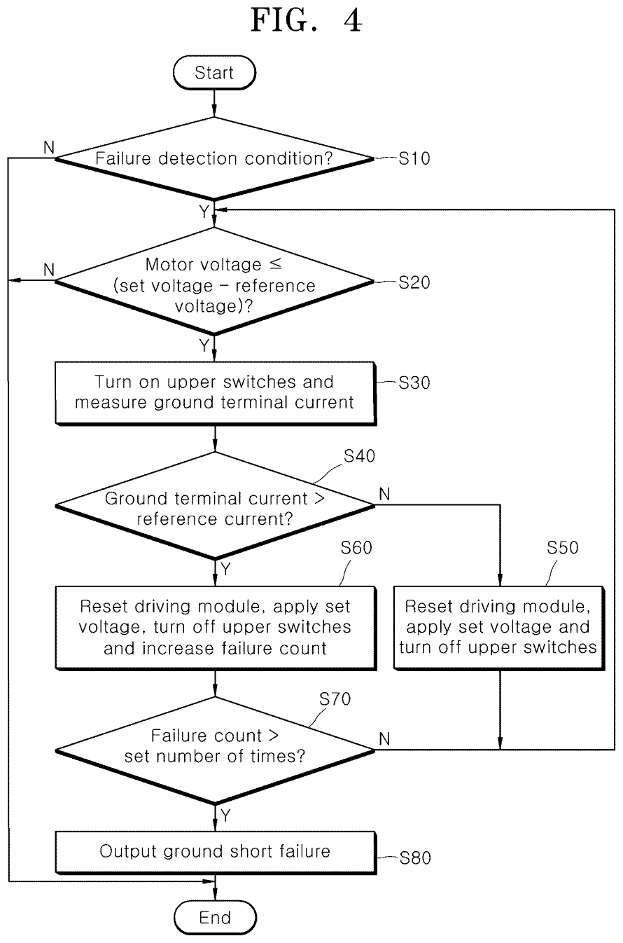

FIG. 4 is a flowchart for explaining a method for detecting a ground short failure in a method for detecting a failure of a driving motor of an electronic parking brake according to an embodiment of the present disclosure.

As illustrated in FIG. 4, in the method for detecting a ground short failure in the method for detecting a failure of a driving motor of an electronic parking brake according to the embodiment of the present disclosure, first, the processor 60 drives an execution program for an apparatus for detecting a failure of a driving motor of an electronic parking brake stored in the memory 50, receives an operation state of a parking brake and a state of a battery inputted from the data input module 10, and determines a failure detection condition based thereon (S10).

As the operation state of the electronic parking brake, each of a standby state, an apply state, a release state and a stop state may be received.

When the electronic parking brake is in the standby state, the driving module 70 may apply a set voltage of about 4 V to both ends of the driving motor 90 to maintain a stable state.

Thus, as the failure detection condition, the processor 60 determines whether the parking brake is in the standby state in which the parking brake is not operated and whether a voltage of the battery is in a stable state.

By determining the failure detection condition in the step S10, if the failure detection condition is satisfied, the processor 60 compares a motor voltage measured across both ends of the driving motor 90 and the set voltage (S20).

In a case where the motor voltage is equal to or less than a voltage obtained by subtracting a reference voltage from the set voltage, if the reference voltage is set to 1V, the processor 60 detects a ground short failure when the motor voltage is equal to or less than 3V, and terminates the process when the motor voltage exceeds 3V.

In the step S20, by comparing the motor voltage and the set voltage, when the motor voltage is equal to or less than the voltage obtained by subtracting the reference voltage from the set voltage, as illustrated in FIG. 2, the processor 60 turns on the first and second MOSFETs F1 and F2, which are the upper switches of the H-bridge module 80, through the driving module 70, and then, measures a ground terminal current through the ground terminal current detection module 30 (S30).

After measuring the ground terminal current in the step S30, the processor 60 determines whether the ground terminal current exceeds a reference current (S40).

In the present embodiment, whether the ground terminal current exceeds 10A is determined. If the ground terminal current does not exceed 10A, the processor 60 determines that the motor voltage has temporarily dropped, resets the driving module 70, applies the set voltage to both ends of the driving motor 90, turns off the upper switches F1 and F2 of the H-bridge module 80, and then, returns to the step S20 to determine whether the motor voltage has dropped (S50). The processor 60 may reset a failure count in the event of a temporary voltage drop like this.

On the other hand, if the ground terminal current exceeds the reference current in the step S40, the processor 60 resets the driving module 70, applies the set voltage to both ends of the driving motor 90, turns off the upper switches F1 and F2 of the H-bridge module 80, and then, increases a failure count (S60).

After increasing the failure count in the step S60, whether the failure count exceeds a set number of times is determined (S70).

When the failure count does not exceed the set number of times in the step S70, the processor 60 returns to the step S20 and repeats the above process from the process of determining whether the motor voltage has dropped.

On the other hand, when the failure count exceeds the set number of times in the step S70, the processor 60 determines a ground short failure of the driving motor 90 and outputs a failure detection result through the output module 100 (S80).

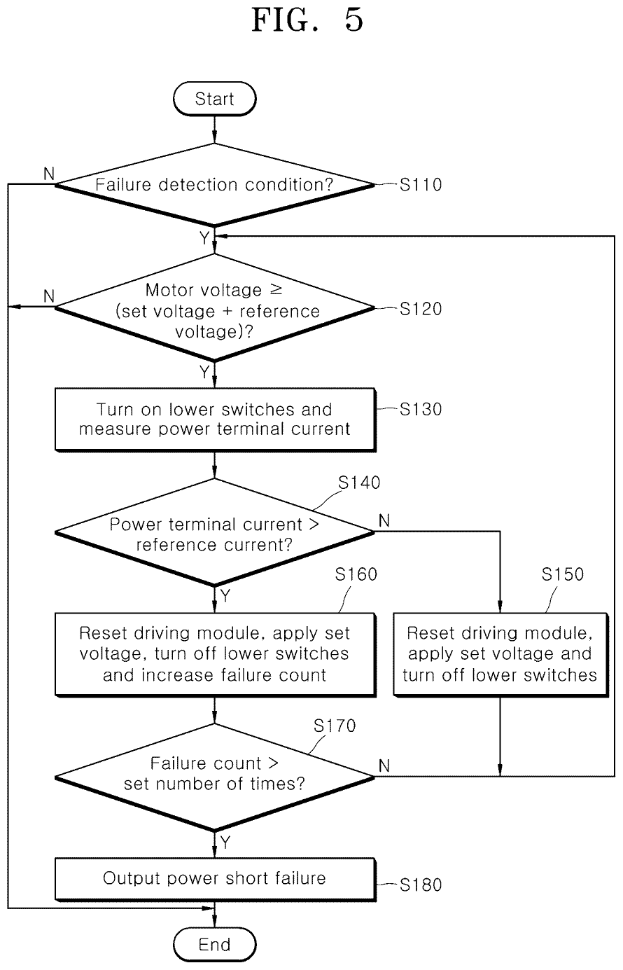

FIG. 5 is a flowchart for explaining a method for detecting a power short failure in the method for detecting a failure of a driving motor of an electronic parking brake according to the embodiment of the present disclosure.

As illustrated in FIG. 5, in the method for detecting a power short failure in the method for detecting a failure of a driving motor of an electronic parking brake according to the embodiment of the present disclosure, first, the processor 60 drives an execution program for an apparatus for detecting a failure of a driving motor of an electronic parking brake stored in the memory 50, receives an operation state of a parking brake and a state of a battery inputted from the data input module 10, and determines a failure detection condition based thereon (S110).

As the operation state of the electronic parking brake, each of a standby state, an apply state, a release state and a stop state may be received.

When the electronic parking brake is in the standby state, the driving module 70 may apply a set voltage of about 4 V to both ends of the driving motor 90 to maintain a stable state.

Thus, as the failure detection condition, the processor 60 determines whether the parking brake is in the standby state in which the parking brake is not operated and whether a voltage of the battery is in a stable state.

By determining the failure detection condition in the step S110, if the failure detection condition is satisfied, the processor 60 compares a motor voltage measured across both ends of the driving motor 90 and the set voltage (S120).

In a case where the motor voltage is equal to or greater than a voltage obtained by adding a reference voltage to the set voltage, if the reference voltage is set to 1V, the processor 60 detects a power short failure when the motor voltage is equal to or greater than 5V, and terminates the process when the motor voltage is less than 5V.

In the step S120, by comparing the motor voltage and the set voltage, when the motor voltage is equal to or greater than the voltage obtained by adding the reference voltage to the set voltage, as illustrated in FIG. 3, the processor 60 turns on the third and fourth MOSFETs F3 and F4, which are the lower switches of the H-bridge module 80, through the driving module 70, and then, measures a power terminal current through the power terminal current detection module 20 (S130).

After measuring the power terminal current in the step S130, the processor 60 determines whether the power terminal current exceeds a reference current (S140).

In the present embodiment, whether the power terminal current exceeds 10A is determined. If the power terminal current does not exceed 10A, the processor 60 determines that the motor voltage has temporarily risen, resets the driving module 70, applies the set voltage to both ends of the driving motor 90, turns off the lower switches F3 and F4 of the H-bridge module 80, and then, returns to the step S120 to determine whether the motor voltage has risen (S150). The processor 60 may reset a failure count in the event of a temporary voltage rise like this.

On the other hand, if the power terminal current exceeds the reference current in the step S140, the processor 60 resets the driving module 70, applies the set voltage to both ends of the driving motor 90, turns off the lower switches F3 and F4 of the H-bridge module 80, and then, increases a failure count (S160).

After increasing the failure count in the step S160, whether the failure count exceeds a set number of times is determined (S170).

When the failure count does not exceed the set number of times in the step S170, the processor 60 returns to the step S120 and repeats the above process from the process of determining whether the motor voltage has risen.

On the other hand, when the failure count exceeds the set number of times in the step S170, the processor 60 determines a power short failure of the driving motor 90 and outputs a failure detection result through the output module 100 (S180).

As is apparent from the above description, according to the method for detecting a failure of a driving motor of an electronic parking brake according to the embodiment of the present disclosure, voltages and currents at both ends of the driving motor are repeatedly measured in a standby state of the electronic parking brake to detect a power short failure and a ground short failure of the driving motor, whereby it is possible to accurately detect a short failure of the driving motor even in a situation of voltage instability and electromagnetic noise.

Although the present disclosure has been disclosed with reference to the embodiments illustrated in the drawings, the embodiments are only for illustrative purposes, and those skilled in the art will appreciate that various modifications and other equivalent embodiments are possible without departing from the scope and spirit of the present disclosure as defined in the accompanying claims. Thus, the true technical scope of the present disclosure should be defined by the following claims.

What is claimed is:

1. An apparatus for detecting a failure of a driving motor of an electronic parking brake, comprising:
a power terminal current detector configured to detect a current flowing through a power terminal of an H-bridge module that supplies power to a driving motor;
a ground terminal current detector configured to detect a current flowing through a ground terminal of the H-bridge module;
a voltage detector configured to detect a motor voltage across both ends of the driving motor;
a motor controller configured to switch the H-bridge module according to a brake operation signal to drive the driving motor, and apply a set voltage to both ends of the driving motor; and
a processor operatively coupled to the power terminal current detector, the ground terminal current detector, the voltage detector and the motor controller,
wherein the processor determines a failure detection condition based on an operation state of a parking brake and a state of a battery inputted from a data input module, and detects a failure of the driving motor by repeating, a set number of times, a process of comparing the motor voltage and the set voltage, measuring each of a power terminal current and a ground terminal current and comparing each of the power terminal current and the ground terminal current with a reference current.

2. The apparatus of claim 1, wherein the failure detection condition is that the parking brake is in a standby state in which the parking brake is not operated and a voltage of the battery is in a stable state.

3. The apparatus of claim 1, wherein, when the motor voltage is equal to or less than a voltage obtained by subtracting a reference voltage from the set voltage, the processor turns on upper switches of the H-bridge module through the motor controller, measures the ground terminal current, repeats the process the set number of times when the ground terminal current exceeds the reference current, and outputs a ground short failure of the driving motor.

4. The apparatus of claim 3, wherein, when repeating the process the set number of times, the processor resets the motor controller, applies the set voltage to both ends of the driving motor, turns off the upper switches of the H-bridge module, and then repeats the process.

5. The apparatus of claim 1, wherein, when the motor voltage is equal to or greater than a voltage obtained by adding a reference voltage to the set voltage, the processor turns on lower switches of the H-bridge module through the motor controller, measures the power terminal current, repeats the process the set number of times when the power terminal current exceeds the reference current, and outputs a power short failure of the driving motor.

6. The apparatus of claim 5, wherein, when repeating the process the set number of times, the processor resets the motor controller, applies the set voltage to both ends of the driving motor, turns off the lower switches of the H-bridge module, and then repeats the process.

7. A method for detecting a failure of a driving motor of an electronic parking brake, comprising:
determining, by a processor, a failure detection condition based on an operation state of a parking brake and a state of a battery inputted from a data input module;
comparing, by the processor, a motor voltage of a driving motor and a set voltage when the failure detection condition is satisfied;
measuring, by the processor, a ground terminal current after turning on upper switches of an H-bridge module through a motor controller when, by comparing the motor voltage and the set voltage, the motor voltage is equal to or less than a voltage obtained by subtracting a reference voltage from the set voltage;
repeating, a set number of times by the processor, a process of measuring and comparing the motor voltage and the ground terminal current when, by comparing the ground terminal current and a reference current, the ground terminal current exceeds the reference current; and
determining a ground short failure of the driving motor after the processor repeats the process the set number of times, and outputting a result.

8. The method of claim 7, wherein, in the repeating, a set number of times, a process of measuring and comparing the motor voltage and the ground terminal current, the processor resets the motor controller, applies the set voltage to both ends of the driving motor, turns off the upper switches of the H-bridge module, and then repeats the process.

9. A method for detecting a failure of a driving motor of an electronic parking brake, comprising:
determining, by a processor, a failure detection condition based on an operation state of a parking brake and a state of a battery inputted from a data input module;
comparing, by the processor, a motor voltage of a driving motor and a set voltage when the failure detection condition is satisfied;
measuring, by the processor, a power terminal current after turning on lower switches of an H-bridge module through a motor controller when, by comparing the motor voltage and the set voltage, the motor voltage is equal to or greater than a voltage obtained by adding a reference voltage to the set voltage;
repeating, a set number of times by the processor, a process of measuring and comparing the motor voltage and the power terminal current when, by comparing the power terminal current and a reference current, the power terminal current exceeds the reference current; and
determining a power short failure of the driving motor after the processor repeats the process the set number of times, and outputting a result.

10. The method of claim 9, wherein, in the repeating, a set number of times, a process of measuring and comparing the motor voltage and the power terminal current, the processor resets the motor controller, applies the set voltage to both ends of the driving motor, turns off the lower switches of the H-bridge module, and then repeats the process.
